(19) United States
(12) Patent Application Publication
(10) Pub. No.: US 2003/0105631 A1
(43) Pub. Date: Jun. 5, 2003

(54) Method for generating transcribed data from verbal information and providing multiple recipients with access to the transcribed data

(76) Inventor: Yosef G. Habte, Tamarac, FL (US)

Correspondence Address: DeScribe, Inc., Suite 200R, 1876 N. University Dr., Plantation, FL, 33322, US

(21) Appl. No.: 09/999,445

(22) Filed: Dec. 3, 2001

(51) Int. Cl. G10L 15/26

(52) U.S. Cl. 704/235

(57) ABSTRACT

A transcription system (100) provides for the automated routing of transcription results of dictation to multiple recipients based on information contained in the dictation. Audio data is obtained that includes verbal information for transcription for a primary recipient (210). The audio data is transcribed and the transcription results stored and made accessible to the primary recipient (220, 230, 240, 250). Routing information is derived from the transcribed data and used to automatically transmit information concerning the transcribed data to a secondary recipient (260).

### FIELD OF THE INVENTION

This invention relates in general to transcription systems and services, and more particularly, to systems that convert verbal information into transcribed data and automatically processes and stores such transcribed data for easy access.

### BACKGROUND OF THE INVENTION

Doctors, lawyers, business professionals and others often use transcription services to assist in the capture and recordation of information. Transcription generally involves the capture of verbal information and its conversion to textual form, but may also involve interpretation and formatting services. Thus, for example, a typical transcriber often performs more than just a literal translation of information from the spoken form to the written form. Traditionally, transcription services have relied mostly on manual processes in which the dictation is recorded, and transferred to a human operator, often a secretary or other assistant, to be typed. In recent times, systems have been introduced or described or that automate certain portions of the transcription process to increase efficiency. A variety of automated solutions have been developed for various subcomponents within the transcription process, and many vendors specialize in particular areas such as automatic voice capturing and audio file generation, and voice recognition. However, there remains an unmet need for the provision of transcription services that are more fully integrated into a user's environment.

For the professional, a transcription service provider should offer accurate, reliable, and cost efficient service. However, the preferred supplier of such services must offer, as much as possible, seamless integration of the service into the professional's work environment. In the medical industry, doctors often dictate patient related information after visiting a patient. This dictation must then be transcribed and made available to the doctor for purposes of review and filing. Patient record information may also be needed by others for a variety of purposes including insurance representatives, referring doctors, and the like. It desirable to have a transcription process that accommodates the various needs of this and other similar work environments in which ready access is needed to transcribed information.

Currently known transcription processes fall short of the integration needed for today's demanding, profit-oriented work environments which require efficiency in all operating aspects of a business. Users are becoming more sophisticated and now desire more automation and more integration of the various components of their systems. There is a need to integrate the output from transcription services in a more seamless manner such that a user of the service may utilize the transcription process as an integral part of their overall offerings. This includes ready access to the transcription results on an as needed basis.

### BRIEF DESCRIPTION OF THE DRAWINGS

The present invention is illustrated by way of example and not limitation in the accompanying figures, in which like references indicate similar elements, and in which:

FIG. 1 is a block diagram of a transcription system for providing substantially automated transcription services, in accordance with the present invention;

FIG. 2 is a diagram showing the flow of operation of the transcription system, in accordance with the present invention;

FIG. 3 is a flow diagram showing one embodiment of a process to obtain an audio file containing dictation, in accordance with the present invention;

FIG. 4 is a flow diagram showing a process to convert an audio file containing dictation into a dictation report, in accordance with the present invention;

FIG. 5 is a flow diagram showing a process to enter transcribed data into a database, in accordance with the present invention;

FIG. 6 a flow diagram showing a process to generate a report using transcribed data from a database, in accordance with the present invention; and

FIG. 7 is a flow diagram showing a process to transmit transcribed data to a secondary recipient, in accordance with the present invention.

### DESCRIPTION OF THE PREFERRED EMBODIMENT

In general, the present invention provides for the automated routing of transcription results of dictation to multiple recipients based on information contained in the dictation. The dictation is represented by audio data that includes verbal information for transcription for a primary recipient. The audio data is obtained and the written text generated from at least a portion of the audio data, thereby generating transcribed data. The transcribed data is stored and made accessible to the primary recipient. Routing information is derived from the transcribed data and used to automatically transmit information concerning the transcribed data to a secondary recipient. In one embodiment, a target address for a secondary recipient, such as a fax number, is derived using information within the transcribed data, and the transcription results tagged with this target address. The transcription results are automatically transmitted to the target address as well as to the primary recipient.

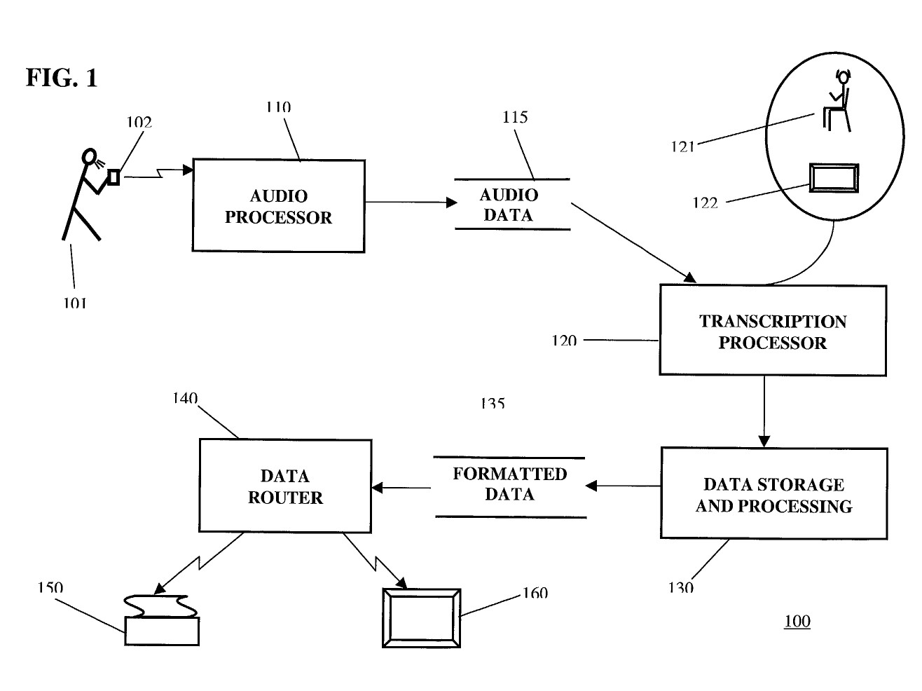

FIG. 1 is a block diagram showing a user interacting with a transcription system 100, in accordance with the present invention. The system 100 includes as major components an audio processor 110, a transcription processor 120, a data storage and processing block 130, and a data router 140. A user 101 is shown interacting with the audio processor 110 through a voice input device 102 such as a digital voice recorder, a telephone interface, or other device that captures human voice input. The voice input device 102 is coupled to the audio processor 110 that accesses an audio data store 115 that is also accessible by the transcription processor 120. The transcription processor 120 includes a human transcriber 121 and an automated machine transcription system 122, which may be used singly or in combination to produce transcribed data 125. The transcribed data 125 is coupled to the data storage and processing block 130 that generates and stores formatted data 135. The data router 140 accesses and routes the formatted data to data output devices that includes a fax machine or networked printer 150 and a terminal or other display device 160.

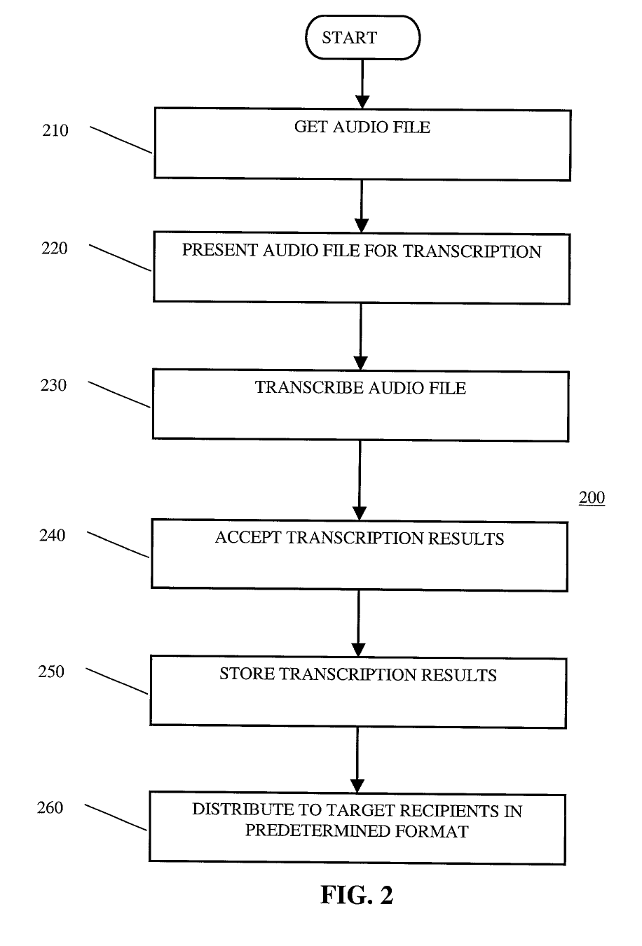

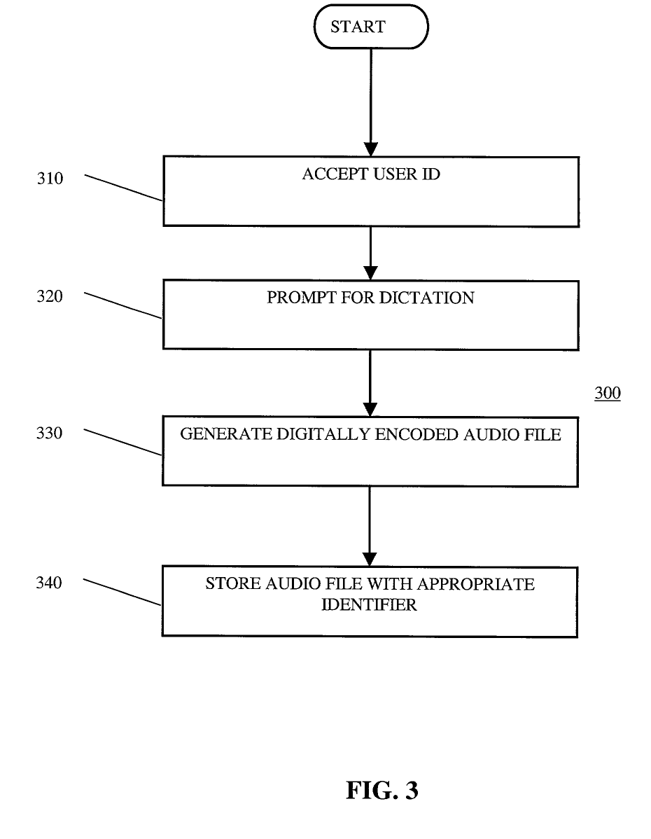

FIG. 2 is a flowchart of procedures 200 showing overall operation of the transcription system, in accordance with the present invention. The transcription process can be segmented into sub-processes such as voice capture, audio file management, transcription and correction, formatting, and results distribution. The transcription process usually begins with voice capture in order to obtain an audio file that includes verbal information for transcription for a particular user, or primary recipient, step 210. The capture or recordation of verbal or spoken information has been traditionally done using a hand-held recordation device such as a tape recorder. However, the use of telephone input systems has gained some prominence because of their universal access. FIG. 3 shows a flowchart 300 of procedures for voice capture in accordance with the present invention. A dictation input system is accessed, via a telephone interface or otherwise, that accepts a user ID corresponding to a system user as part of a user identification or authentication process, step 310. The system user is then prompted for the dictation or spoken information, step 320. The dictation or spoken information is then sampled to generate digitally encoded audio, step 330. The audio data is stored in a digital audio file having a file identifier derived using the user identifier and representative of the primary recipient for the corresponding transcribed data. While a telephone interface voice capture system is described for the preferred embodiment, one skilled in the art would recognize that other voice input mechanisms may be used. For example, in an alternative embodiment, a digital hand-held voice recorder is used to generate digitally encoded voice data that is linked or networked into the transcription system.

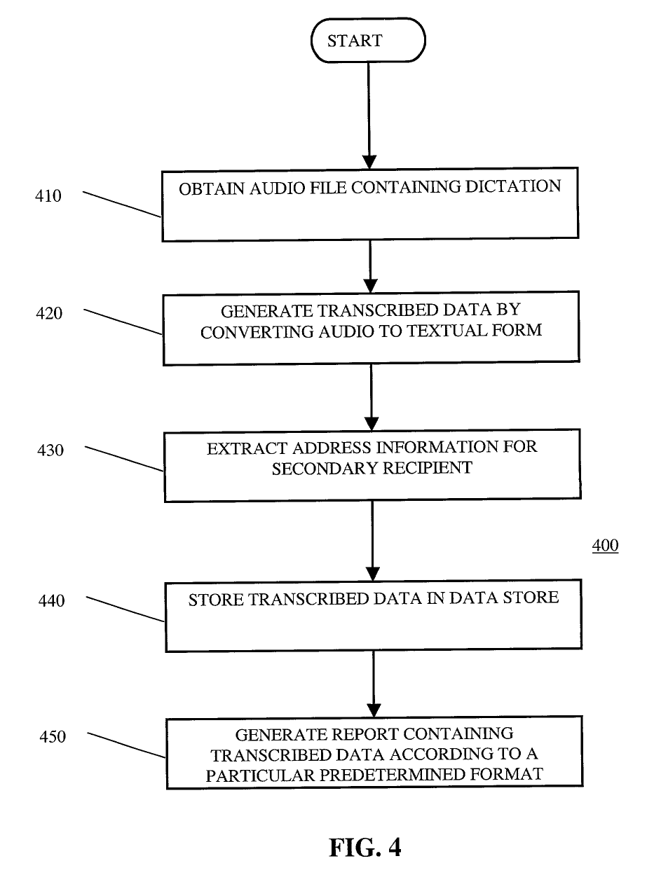

After the audio file has been generated and stored through the voice capture process, the audio file is presented for transcription, step 220. Preferably, the file containing the audio data is transmitted across a computer network to a transcription processor, such as a human operator or to a computer with speech recognition software. The transcription processor then transcribes the audio file, i.e., converts the verbal information within the audio file to textual form and executes corresponding instructions, step 230. FIG. 4 shows a flowchart of procedures 400 used by the transcription processor, in accordance with the present invention. The audio file containing the dictation is first obtained such as by downloading the file from a server, step 410. Alternatively the audio file may be sent directly to the transcription processor using one of the push technologies commonly available over the Internet. The dictation represented by the audio file is converted from audio to contextual form thereby generating transcribed data, step 420. The actual transcription may be done by a human operator or by an automated machine, such as a computer executing speech recognition software, or by a combination of both.

According to the invention, as part of the process, the audio data or corresponding transcribed data is parsed to extract address information for a secondary recipient for the transcription results, step 430. The address information is preferably used to derive a telephone number associated with a facsimile machine accessible to the secondary recipient, an Internet Protocol (IP) address for a networked printer or device, an e-mail address, or the like. In one embodiment, the address information is used to form tags or meta-tags that are associated with or used as part of an identifier for the transcription results. In another embodiment, address information such as facsimile telephone numbers are used as part of file identifiers for the transcribed data.

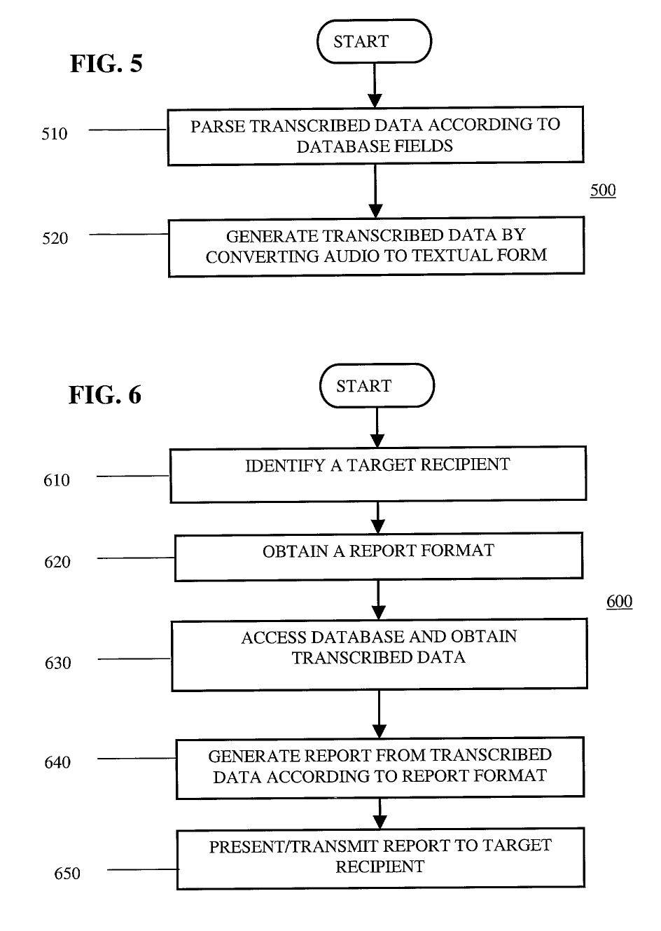

The transcribed data is preferably stored in a data store such as a database or data file, step 440. In one embodiment highlighted in the procedures 500 shown in FIG. 5, the transcribed data is parsed according to database fields of a corresponding database, step 510, such as through the use of a data entry form. The parsed data is then stored in the database, step 520, and made available for further processing. In lieu of or in addition to storage of the data in the database, the data may be arranged according to a predetermined format in a standard word processor document. Preferably, the database is then used to generate a report containing at least a portion of the transcribed data according to a particular predetermined format, step 450. Multiple reports of a variety formats may be generated using the transcribed data stored in the database. The database is preferably made accessible to the primary recipient of the information through a variety of access and reporting tools. For example, an on-demand report containing formatted transcribed data is generated from the database is in response to a command received via a web browser interface. The report is made available to the primary recipient, and also to selected secondary recipients. In another embodiment, the transcribed data is stored in a data file, such as a formatted word processor document identified such as by a filename using information pertaining to the primary recipient and routing information related to a secondary recipient.

FIG. 6 shows a flowchart of procedures 600 for formatting and transmitting information derived from the transcribed data stored in a database, in accordance with present invention. Information is obtained concerning the identity or address and report format requirements for a particular target recipient for transcribed data, steps 610, 620. As indicated earlier, the address may represent a variety of target devices such as facsimile machines, display devices such as Web browsers, printers, and the like. The database is then access to obtain transcribed data, and a report, according to the desired format, is generated using the transcribed data, steps 630, 640. The report is then presented or transmitted, via an electronic file, to the device of a target recipient using the supplied address information step 650. The previous steps are preferably automatically performed in response to the availability of transcribed data.

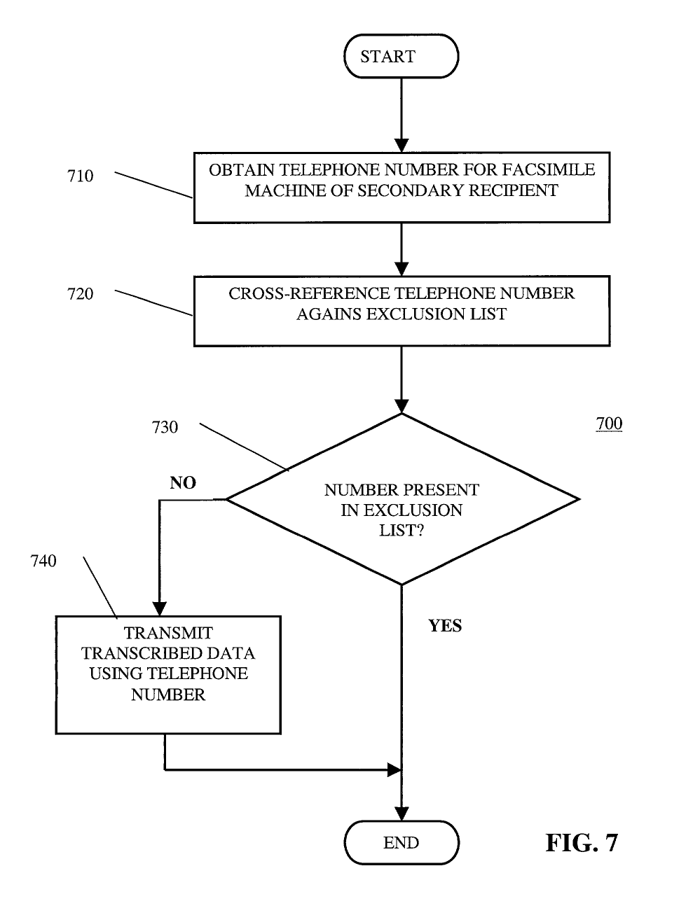

According to a further aspect of the invention, steps are taking to ensure that a transcription report is not inadvertently sent to an unintended recipient. FIG. 7 is a flowchart of procedures 700 of one such precautionary measure. The system obtains a telephone number associated with a facsimile machine accessible to a target recipient, such as the secondary recipient, step 710. The telephone number is cross-referenced with an exclusion list of telephone numbers for which no facsimile transmission is permitted step 720. When the telephone number is not contained in the exclusion list, our report containing at least a portion of the transcribed data is transmitted by facsimile using the telephone number, steps 730,740. When the telephone number is contained in the exclusion list, facsimile transmission of the report containing the transcribed data using the telephone number is prohibited to, step 730. Use of an exclusion list to prohibit transmission to networked devices is also contemplated by this invention.

The present invention provides significant benefits in the art of transcription processing. For example, by utilizing a database to capture transcribed data and by generating transcription reports according to predetermined formats, a variety of transcription needs may be accommodated. Additionally, by extracting routing information derived from the transcribed data and automatically routing transcription results accordingly, substantial flexibility is achieved for distributing transcription reports.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. In a computer network environment, a method for generating transcribed data from verbal information and providing access to the transcribed data to a primary recipient and a secondary recipient, the method comprising the steps of:
obtaining audio data that includes verbal information for transcription for a primary recipient;
generating transcribed data from the audio data, including text from at least a portion of the audio data;
storing the transcribed data in a location accessible to the primary recipient; and
automatically transmitting information concerning the transcribed data to a secondary recipient using information derived from the transcribed data.

2. The method of claim 1, wherein the step of obtaining audio data comprises the steps of:
accepting a user identifier corresponding to a system user;
verbally prompting the system user for spoken information;
sampling the spoken information to generate the audio data; and
storing the audio data in a digital audio file having a file identifier derived using the user identifier and representative of the primary recipient.

3. The method of claim 1, wherein the step of generating transcribed data comprises the steps of:
transmitting the audio data across a computer network to a human operator;
transcribing, by the human operator, at least a portion of the audio data into textual data; and
generating a report containing the textual data according to particular pre-determined format.

4. The method of claim 1, wherein the step of automatically transmitting information comprises the steps of:
obtaining an address based on information contained in the transcribed data; and
transmitting to the address at least a portion of the transcribed data.

5. The method of claim 4, wherein the step of transmitting to the address comprises the step of transmitting by facsimile transmission the at least portion of the transcribed data.

6. The method of claim 5, wherein the step of transmitting by facsimile transmission comprises the steps of:
obtaining a telephone number associated with a facsimile machine accessible to the secondary recipient;
cross-referencing the telephone number with an exclusion list of telephone numbers for which no facsimile transmission is permitted;
transmitting the at least portion of the transcribed data using the telephone number when the telephone number is not contained in the exclusion list; and
prohibiting transmission of the at least portion of the transcribed data using the telephone number when the telephone number is contained in the exclusion list.

7. The method of claim 4, wherein the step of transmitting to the address comprises the step of transmitting via an electronic file the at least portion of the transcribed data.

8. The method of claim 4, further comprising the step of tagging the at least portion of the transcribed data with the address.

9. The method of claim 8, further comprising the steps of:
generating a formatted file using the at least portion of the transcribed data; and
generating a filename for the formatted file that includes the address.

10. The method of claim 1, wherein the step of storing comprises the step of placing the transcribed data in a data file identified as corresponding to the primary recipient.

11. The method of claim 1, wherein the step of storing comprises the steps of: parsing and storing the transcribed data according to data fields of a corresponding database.

12. The method of claim 11, further comprising the step of generating an on-demand report from the database in response to a command received via a web browser interface.

13. In a computer network environment, a method for generating transcribed data from verbal information and providing access to the transcribed data to a primary recipient and a secondary recipient, the method comprising the steps of:
obtaining audio data that includes verbal information for transcription for a primary recipient;
generating transcribed data from the audio data, including text from at least a portion of the audio data, including the steps of:
transmitting the audio data across a computer network to a human operator;
transcribing, by the human operator, at least a portion of the audio data into textual data; and
storing the textual data in a location accessible to the primary recipient; and
obtaining address information for a secondary recipient using information contained in the transcribed data;
automatically transmitting a formatted report containing the textual data to the secondary recipient using the address information.

14. The method of claim 13, wherein the step of automatically transmitting comprises the step of storing the formatted report in a file with a filename containing the address information.

15. The method of claim 14, wherein the filename contains a telephone number associated with a facsimile machine accessible by the secondary recipient.

16. The method of claim 11, wherein the step of storing comprises the steps of: parsing and storing the transcribed data according to data fields of a corresponding database.

17. The method of claim 16, further comprising the step of generating an on-demand report from the database in response to a command received via a web browser interface.
